(19) United States
(12) Patent Application Publication
(10) Pub. No.: US 2003/0224029 A1
(43) Pub. Date: Dec. 4, 2003

(54) Insect repellant

(75) Inventor: James F. White, Cape Elizabeth, ME (US)

Correspondence Address: Kevin M. Farrell, Kevin M. Farrell, P.C., 18 York Street, P.O. Box 999, York Harbor, ME, 03911, US

(73) Assignee: Holy Terra Products, Inc., Cape Elizabeth, ME (US)

(21) Appl. No.: 10/159,624

(22) Filed: May 31, 2002

(51) Int. Cl. A01N 65/00; A01N 25/00; A01N 25/34

(52) U.S. Cl. 424/405; 424/754; 424/760; 424/761

(57) ABSTRACT

Disclosed are compositions and methods for repelling insects. The composition is formulated as an aqueous solution to be sprayed on a surface from which insects are to be repelled. In preferred embodiments, the composition is a non-toxic and biodegradable insect repellent comprising an aqueous carrier, at least about 0.05 percent by volume of hot pepper extract, at least about 0.05 percent by volume of garlic extract, and at least about 0.05 percent by volume of Neem seed oil.

### BACKGROUND OF THE INVENTION

Damage caused to plants by insects is a huge commercial problem. This statement applies, for example, to food crops and ornamental plants. Many of the insect repellents and pesticides marketed currently for use in connection with mitigating this damage are highly toxic presenting dangers both known and unknown.

Prior art insect repellents have been formulated from naturally occurring and biodegradable active ingredients. A composition formulated from naturally occurring and biodegradable active ingredients which demonstrates increased effectiveness and/or other advantages relative to the prior art formulations would represent a significant advance in the art.

### SUMMARY OF THE INVENTION

The present invention relates to compositions and methods for repelling insects. The composition is formulated as an aqueous solution to be sprayed on a surface from which insects are to be repelled. In preferred embodiments, the composition is a non-toxic and biodegradable insect repellent comprising an aqueous carrier, at least about 0.05 percent by volume of hot pepper extract, at least about 0.05 percent by volume of garlic extract, and at least about 0.05 percent by volume of Neem seed oil.

### DETAILED DESCRIPTION OF THE INVENTION

The present invention relates to a non-toxic and biodegradable insect repellent. The insect repellent is formulated as an aqueous solution suitable for application to a surface by spraying. The insect repellent of the present invention is useful when applied to the surface of a plant, or any substantially inanimate surface. The former class includes any terrestrial plant. This class includes food crops, as well as ornamental plants. Examples of commercially significant food crops include corn, soy bean, wheat, apples, grapes, tomato and potato. The latter class (i.e., substantially inanimate surfaces) include, for example, masonry, wood and soil surfaces.

The formulation is comprised principally of an aqueous carrier. The active ingredients include hot pepper extract, garlic extract and Neem seed oil. The term “extract” as used in connection with the hot pepper and garlic components, refers to the filtrate of a puree of hot pepper and/or garlic (i.e., the puree can produced from garlic alone, hot pepper alone, or a combination puree of hot pepper and garlic).

A concentrated hot pepper extract was produced by pureeing at least about 0.50 pounds of whole hot peppers per gallon of water. Preferably, the hot pepper is of the genus Capsicums. A further preference is for the species frutenscens. A particularly preferred variety of Capsicums frutescens is the habanera pepper. The puree was filtered and the filtrated collected as the hot pepper extract.

A concentrated garlic extract was produced by pureeing at least about 0.10 pounds of whole garlic cloves per gallon of water. The garlic Allium sativum was used in the formulation. The puree was filtered and the filtrated collected as the garlic extract.

A third active ingredient is Neem seed oil. Seeds from the Neem tree are collected and pressed to yield pure Neem seed oil. The source of the need seed oil used in the experiments described below was Dyna-Gro, Inc., San Pueblo, Calif. Neem oil, in addition to being a natural insect repellent, also serves to inhibit insect reproduction.

The extracts of hot pepper and garlic, as well as the Neem oil, were formulated in an aqueous carrier at a wide range of concentrations (typically expressed as percent by volume). It was determined that the hot pepper extract, garlic extract, and Neem seed oil were effective when each comprised at least about 0.05 percent by volume of the ready-to-apply formulation. The upper range is dictated primarily by practical considerations, such as cost. Increasing the percentages of the active ingredients over those specified above does not substantially increase the effectiveness of the composition.

### Exemplification

In the experiments described in this section, the effectiveness of the composition of the present invention as an insect repellent was demonstrated on plants pre-infected with an insect population (referred to herein as the “infected” population), as well as plants not exposed to insects prior to application of the repellent composition (referred to herein as the “non-infected” population).

The plants used in the experiments described herein were lettuce (Lactuca serriola). The insects used in the experiments described herein were the Whitefly (Trialeurodes vaporariorum). For each of the seven compositions tested, ten plants were used. The ten plants were divided into two groups of five per group. One group of five was pre-infected with Whitefly. More specifically, fifty insects were applied to the plant by being shaken from a vial known to contain exactly fifty insects. Each plant was grown in isolation from all others. It is known from numerous control experiments that when fifty Whiteflies are shaken onto an untreated lettuce plant, the fifty flies remain on the plant and feed until the plant is defoliated. The second group of five plants comprise the non-infected population. The non-infected population is sprayed with the composition to be tested (as described below) prior to the introduction of Whitefly.

For each composition, one gallon of the composition to be tested was blended. The concentrations of the active ingredients in the composition as applied was always the same, whether the active ingredients were used independently, or in combination. More specifically, the concentrations were 0.75% pepper, 0.30% garlic and 0.05% Neem oil. The entire gallon of the relevant composition was applied to the ten plants in the test group over a ten day period (once daily).

With respect to the hot pepper and garlic components of the formulation, the relative quantities are expressed as a percent by volume of the final insect repellent formulation, of an extract of pepper or garlic. The terms “hot pepper extract” or “garlic extract” are best defined by describing their method of production. Essentially, the hot pepper and garlic extracts are the filtrate yielded from a puree of whole hot peppers and garlic cloves.

It has been determined that efficient extraction of active ingredients from whole hot peppers and garlic cloves can be achieved by adding the following ingredients to a blender: 16 ounces of water, about 10-12 whole hot peppers (preferably habanero), and about 5 garlic cloves. The ingredients are then pureed and resulting puree is filtered to remove the mash component. This relationship of ingredients has been maintained in scaled up commercial production runs of up to 120 gallons per run. In all tests, similar effectiveness was observed. For experiments in which only a single extract was used in the formulation, the concentration of the active ingredient in the filtrate was held constant relative to the pepper and garlic extract described above. For example, the composition 1 extract was prepared by pureeing 10-12 hot peppers in 16 ounces of water.

The Neem oil component was obtained as pure oil form from Dyna-Gro, San Pueblo, Calif. This oil is produced by pressing seeds from the Neem tree.

The experiment was scored as to effectiveness by counting the number of insects found on each plant at the end of the 10-day experimental period. The insect counts for the five infected plants were combined for scoring purposes, as were the insect counts for the five non-infected plants. As an example of how effectiveness was calculated, consider the Composition 1 scoring shown below in Table 1. The Composition 1 formulation was determined to be 57% effective on the five infected plants. This was determined by counting the insects remaining on the plants at the end of the 10-day period, subtracting that number from 250 (the total number of insects applied to the five plants) and expressing the difference as a percentage. Thus, in the instance under consideration, 107 insects were counted on the plants at the end of the 10-day period. 57% of the total number of insects ((0.57)(250)=142.5) were repelled from the plant by Composition 1 treatment.

Table 1

| | |
|---|---|
| Active | Effectiveness |

| Composition | Ingredient (s) | Infected | Non-Infected |
|---|---|---|---|
| 1 | hot pepper | 57% | 35% |
| | extract | | |
| 2 | garlic extract | 35% | 67% |
| 3 | Neem seed oil | 22% | 35% |
| 4 | hot pepper and | 83% | 92% |
| | garlic extract | | |
| 5 | hot pepper and | 68% | 78% |
| | Neem seed oil | | |
| 6 | garlic extract | 33% | 65% |
| | and Neem seed oil | | |
| 7 | hot pepper, | 92% | 99% |
| | garlic and Neem | | |
| | seed oil | | |

The results summarized in Table 1 demonstrate the superior effectiveness of the compositions of the present invention relative to formulations containing any one or two of the active ingredients at substantially identical concentrations.

1. A non-toxic and biodegradable insect repellent comprising:
a) an aqueous carrier;
b) at least about 0.05 percent by volume of hot pepper extract;
c) at least about 0.05 percent by volume of garlic extract; and
d) at least about 0.05 percent by volume of Neem seed oil.

2. The insect repellent of claim 1 wherein hot pepper extract comprises a filtrate of a puree, the puree being produced using a ratio of hot pepper to aqueous carrier of at least about 0.50 pounds per gallon.

3. The composition of claim 2 wherein the hot pepper is of the genus Capsicums.

4. The composition of claim 3 wherein the pepper is Capsicums frutescens.

5. The composition of claim 4 wherein the Capsicums frutescens variety is the habanera pepper.

6. The insect repellent of claim 1 wherein garlic extract comprises a filtrate of a puree, the puree being produced using a ratio of garlic cloves to aqueous carrier of at least about 0.10 pounds per gallon.

7. The composition of claim 6 wherein the garlic extract is produced from the garlic Allium sativum.

8. The composition of claim 1 wherein the Neem seed oil is produced by pressing seeds of the Neem tree.

9. A method for repelling insects, the method comprising:
a) providing a non-toxic and biodegradable insect repellent comprising:
i) an aqueous carrier;
ii) at least about 0.05 percent by volume of hot pepper extract;
iii) at least about 0.05 percent by volume of garlic extract; and
iv) at least about 0.05 percent by volume of Neem seed oil; and
b) applying the composition of step a) to an area from which insects are to be repelled, the area comprising the surface of a plant or a substantially inanimate surface.

10. The method of claim 9 wherein the plant is a terrestrial plant.

11. The method of claim 10 wherein the terrestrial plant is a food crop.

12. The method of claim 11 wherein the food crop is selected from the group consisting of corn, soy bean, wheat, apples, grapes, tomato and potato.

13. The method of claim 9 wherein the composition is applied by spraying.

14. The method of claim 9 wherein the hot pepper extract comprises a filtrate of a puree, the puree being produced using a ratio of hot pepper to aqueous carrier of at least about 0.50 pounds per gallon.

15. The method of claim 14 wherein the hot pepper is a habanero pepper.

16. The method of claim 9 wherein garlic extract comprises a filtrate of a puree, the puree being produced using a ratio of garlic cloves to aqueous carrier of at least about 0.10 pounds per gallon.

17. The method of claim 16 wherein the garlic extract is produced from the garlic Allium sativum.

18. The method of claim 9 wherein the Neem seed oil is produced by pressing seeds of the Neem tree.
